(19) United States
(12) Patent Application Publication
(10) Pub. No.: US 2005/0066908 A1
(43) Pub. Date: Mar. 31, 2005

(54) Cage for breeding of lab animal

(76) Inventor: Chean-Gui Park, Seoul (KR)

Correspondence Address: PARK & SUTTON LLP, 3255 WILSHIRE BLVD, SUITE 1110, LOS ANGELES, CA, 90010, US

(21) Appl. No.: 10/501,046

(22) PCT Filed: Jan. 17, 2003
(86) PCT No.: PCT/KR03/00103

(30) Foreign Application Priority Data
Jan. 17, 2002 (KR) 10-2002-0002829
Jan. 17, 2002 (KR) 10-2002-0002835
Jan. 17, 2002 (KR) 10-2002-0002845

(51) Int. Cl. A01K 1/03

(52) U.S. Cl. 119/419

(57) ABSTRACT

Disclosed is a cage for breeding laboratory animals. The laboratory animal breeding cage can detachably couple a lid to a body of the cage in a simple manner. Further, by virtue of a double filter mounted in the lid, the laboratory animals can be bred under both positive and negative pressure. Furthermore, by virtue of a double safety valve, the inside and the outside of the cage can be doubly air-blocked. The cage can be conveniently washed an managed, the cause of failure is eliminated and a life span of the cage is lengthened, and the efficiency in breeding and controlling the laboratory animals are enhanced.

### TECHNICAL FIELD

The present invention relates to a cage for breeding laboratory animals, and more particularly, to a cage for breeding laboratory animals, which can detachably couple a lid to a body of the cage in a simple manner, permit the laboratory animals to be bred under both positive and negative pressure by means of a double filter mounted on the lid, and doubly isolate air in the inside of the cage from air outside by means of a double safety valve for air supply.

### BACKGROUND ART

Much Study has been made to develop a cage for efficiently breeding laboratory animals.

An in-vivo experiment on laboratory animals, such as mice or rats has been made to know the effect or the poisonous properties of a medicine. The laboratory animals are bred in a cage at an appropriate temperature in a germfree state while being supplied with feed, water and air.

A conventional cage for breeding laboratory animals has no filter mounted on an exhaust part thereof. If any, a small cylindrical filter is provided such that contaminants are accumulated in an exhaust pipe and accordingly the filter needs to be replaced with new one frequently.

Another conventional cage is structured such that one filter is mounted on the cage and contaminated air in the cage is discharged through the filter to an exhaust pipe connected to the outside. This type of conventional cage cannot be applied to a clinical trial which requires a negative pressure condition where the pressure in the cage is lower than the pressure outside. Thus, it is disadvantageous in that a positive pressure-type cage and a negative pressure-type cage should be separately prepared.

Further, in the conventional prior art, there is no apparatus for fixing a lid to a body of the cage. When the cage needs to be moved to another place, a person should place the hand at the bottom of the cage and then carry the cage to the new place. Alternatively, an additional apparatus for fixing the lid to the body of the cage is attached to the lid or the body. Even in this case, the conventional prior art is inconvenient in that the lid fixing apparatus needs to be separately operated and it is hard to wash the apparatus.

Furthermore, in the conventional prior art, when the cage for breeding the laboratory animals is pushed into toward a rack, a germfree air nozzle pipe fixed to the rack pushes a valve attached to the cage to open the valve so that air is supplied to the inside of the cage. When the cage is pulled out from the rack, the valve is closed such that the cage becomes airtight and air in the cage is isolated from external air, thereby preventing contamination.

However, when the laboratory animals are bred in the conventional cage, body wastes are accumulated, and various dust particles and small pieces of bedding laid on the floor of the cage are generated. When the bedding is replaced or the cage is cleaned or washed, the dust particles and small pieces are introduced into the opening formed by the valve. As a result, the valve operates poorly and airtight condition in the cage is not ensured, thereby causing air contamination.

Korean Patent Registration No. 10-0353601 discloses a cage for breeding laboratory animals in which a feed tray and a water bottle are removably mounted to the cage in an airtight manner, so that the laboratory animals are prevented from dying after infection from various kinds of germs introduced from the outside.

Korean Utility Model Registration No. 20-0208352 discloses an apparatus for eliminating odor from a cage for small animal care, which is useful for breeding, rearing, safekeeping or experimenting on small animals.

### DISCLOSURE OF INVENTION

The present invention relates to a cage for breeding laboratory animals.

A laboratory animal breeding cage having a lid fixing apparatus includes a lid 10 and a knob 11 integrally formed with the lid 10 in the middle of the lower end of the front part of the lid 10. The knob 11 is bent toward the inner surface of a fixed jaw 32 of a body 30 and then downwardly inclined toward the outside. The lid 10 includes fixed jaw-catching members integrally formed therewith at both right and left sides of the lower end of the rear part thereof. The fixed jaw-catching members are bent toward the inner surface of the fixed jaw 32 of the body 30. The fixed jaw 32 to which the knob 11 and the fixed jaw-catching members are fixed is integrally formed with the body along the edges of the top portion of the body 30 to be coupled to the lid 10.

A method for coupling the lid to the body of the cage will be explained as follows.

First, the two fixed jaw-catching members formed at the rear part of the lid 10 are placed on the fixed jaw 32. When the knob 11 formed at the front part of the lid 10 is pressed downwardly, it is snap-fitted onto the fixed jaw 32 due to tensile force of the knob 11 and the body 30. As a consequence, the lid 10 and the body 30 are closely coupled to each other.

Further, a method for detaching the lid from the body of the cage will be explained as follows.

First, the knob 11 formed at the front part of the lid 10 is pulled outwardly and lifted up to be separated from the fixed jaw 32 of the body 30. Then, the fixed jaw-catching members formed at the rear part of the lid 10 are separated from the fixed jaws 32. As a result, the lid 10 can be easily detached from the body 30.

In a cage for breeding laboratory animals having a double filter 13, an air supply valve 31 is mounted on one side of the body 30 and adapted to allow air to be introduced into the body 30 therethrough. A plurality of exhaust holes 18 are formed all over the top and bottom surfaces of the lid 10. An outer filter 13a is disposed beneath the top surface of the lid 10. An exhaust space 19 is formed between an outer filter fixing frame 11a and an inner filter fixing frame 11b which are disposed beneath the outer filter 13a. The inner filter 13b is located beneath the inner filter fixing frame 11b. A filter fixing plate 12 is attached to the bottom surface of the lid 10. The outer filter 13a, the outer filter fixing frame 11a, the inner filter fixing frame 11b, the inner filter 13b and the filter fixing plate 12 are fixedly secured to each other to form the lid. Further, an exhaust outlet 14 is formed at one side of the lid 10 in such a manner as to communicate with the exhaust space 10.

In the meantime, when air pressure in the laboratory animal breeding cage having the double filter is higher than air pressure outside, that is, in case of positive air pressure, air flows as follows. Air introduced into the body 30 through the air supply valve 31 is used for animal respiration. When the air is contaminated, the contaminated air is discharged to the exhaust space 19 after being filtered by the inner filter 13b. At this time, 70 to 80% of air among the whole air introduced into the exhaust space 19 is discharged through the exhaust outlet 14 to an exhaust pipe 50. At the same time, 20 to 30% of the air is passed through the outer filter 13a due to a difference between the air pressure inside the cage and the air pressure outside so as to be filtered and further passed through the exhaust holes 18 formed on the top surface of the lid 10 toward the outside.

In the meantime, when the air pressure in the cage is lower than the air pressure outside, that is, in case of negative pressure in the cage, air flows as follows. Air introduced into the body 30 of the cage through the air supply valve 31 is used for animal respiration. When the introduced air is contaminated, the contaminated air is discharged to the exhaust space 19 after being filtered by the inner filter 13b. Then, the contaminated air is discharged through the exhaust outlet 14 to the exhaust pipe 50. At the same time, external air is sucked into the cage by the outer filter 13a due to a difference between the air pressure inside the cage and the air pressure outside, and then discharged through the exhaust space 19 to the exhaust pipe 50. In consequence, the negative pressure inside the cage is constantly maintained. At this time, the negative pressure in the cage is formed by making air pressure of the air introduced into the air supply valve 31 be 10 to 20% lower than the suction force of the exhaust outlet 14.

In a cage for breeding the laboratory animals having a double safety valve for air supply, the double safety valve includes a valve body 43, a fixing sleeve 47, an outer valve 46 having a first spring 45 embedded therein and interposed between the valve body 43 and the fixing sleeve 47 in such a manner as to be mounted to the inside of the valve body 43 by means of the fixing sleeve 47, and an inner valve 42 mounted to the outside of the valve body 43 opposite to the inside of the valve body 43 to which the outer valve 46 is mounted. The inner valve 42 and the outer valve 46 are coupled to each other by means of a clamping bolt 41 and a stop nut 48. The inner and outer valves are opened when being pressed by a silicon rod 63 connected to a second spring 64 of an air nozzle pipe 62 which is fixed to a rack.

Three to five guide wing parts 46a extend from the outer valve 46 and are adapted to guide the outer valve 46 to move in the valve body 43. A plurality of vent holes 42a are formed on the inner valve 42 to let air pass therethrough.

The double safety valve 40 for air supply doubly isolates air inside the cage from air outside, thereby making the cage airtight. The double safety valve 40 prevents dust particles or small pieces of the bedding from being infiltrated into an opening formed thereby during washing or moving the cage, thereby decreasing failure rate. The inner valve 42 and the outer valve 46 included in the double safety valve 40 are coupled to each other with the clamping bolt and the stop nut, thereby being easily replaced with new ones.

The operation of the double safety valve for air supply will be described hereinbelow.

When the cage is pushed into the rack, an air supply sleeve 61 surrounds the double safety valve 40 while the silicon rod 63 connected to the second spring 64 mounted on the air nozzle pipe 62 applies pressure to the rear surface of the double safety valve 40.

Accordingly, the first spring 45 of the double safety valve 40 is compressed. The outer valve 46 is moved into the valve body 43 so as to be opened. The inner valve 42 connected to the outer valve is also pushed into the body 30 so as to be opened.

When the double safety valve is opened, germfree air passed through the air nozzle pipe 62 which is secured to an air supply pipe 60 is passed through the second spring 64, and then passed through the outer valve and the inner valve 42 of the double safety valve 40 to be introduced into the body 30.

Meanwhile, since the air supply sleeve 61 of a small cymbal shape is mounted at the front part of the air nozzle pipe 62, external air is prevented from being introduced into the air supply sleeve 61, and when the air pressure in the cage is excessively high, the air leaks out. Therefore, excessive pressure is prevented and the amount of air supplied to the cage is constantly maintained.

When the cage for breeding the laboratory animals is pulled out from the rack, the double safety valve 40 is separated from the air supply sleeve 61 and is returned to its original state, namely, the closed state, due to the restoring force of the first spring 45.

### BRIEF DESCRIPTION OF THE DRAWINGS

Further objects and advantages of the invention will be more fully understood from the following detailed description taken in conjunction with the accompanying drawings in which:

FIG. 1 is a perspective view illustrating a front part of laboratory animal breeding cage having a lid fixing apparatus according to the present invention;

FIG. 2 is a perspective view illustrating a rear part of the laboratory animal breeding cage having the lid fixing apparatus according to the present invention;

FIG. 3 is an exploded perspective view of the laboratory animal breeding cage having the lid fixing apparatus according to the present invention;

FIG. 4 is a cross-sectional view of the laboratory animal breeding cage having the lid fixing apparatus according to the present invention;

FIG. 5 is a perspective view illustrating a laboratory animal breeding cage having a double filter according to the present invention, in which an air supply pipe and an exhaust pipe are coupled to laboratory animal breeding cage;

FIG. 6 is a cross-sectional view illustrating air flow when the laboratory animal breeding cage having the double filter is under positive pressure according to the present invention;

FIG. 7 is a cross-sectional view illustrating air flow when the laboratory animal breeding cage having the double filter is under negative pressure according to the present invention;

FIG. 8 is an exploded perspective view of a lid at which the double filter is mounted according to the present invention;

FIG. 9 is a perspective view illustrating a layered state of the lid at which the double filter is mounted according to the present invention;

FIG. 10A is a cross-sectional view illustrating a state in which a double safety valve for air supply is closed before being coupled to an air supply sleeve according to the present invention;

FIG. 10B is a cross-sectional view illustrating a state in which the double safety valve for air supply is opened after being coupled to the air supply sleeve according to the present invention;

FIG. 11 is an exploded perspective view of the double safety valve for air supply according to the present invention;

FIG. 12A is a front view of the double safety valve, illustrating a state in which the double safety valve for air supply is assembled according to the present invention; and

FIG. 12B is a rear view of the double safety valve, illustrating a state in which the double safety valve for air supply is assembled according to the present invention.

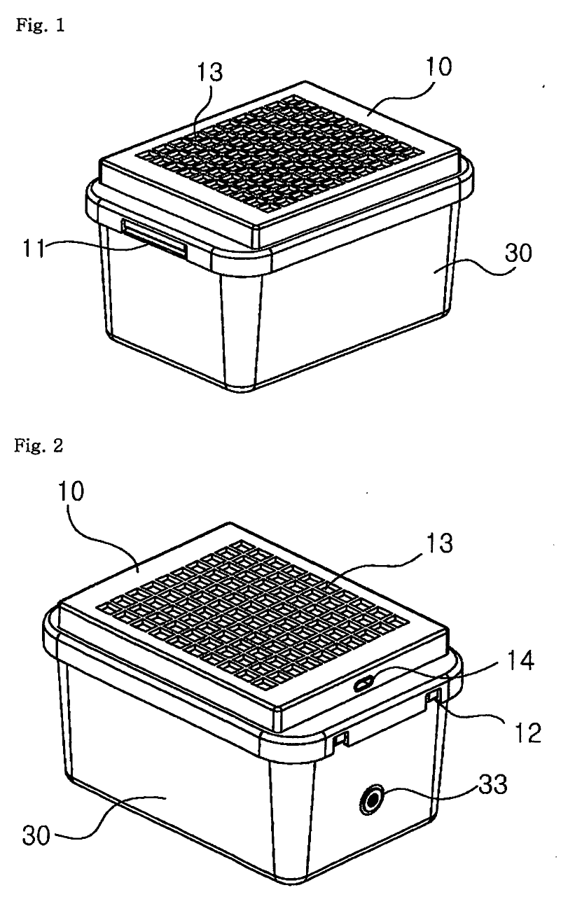

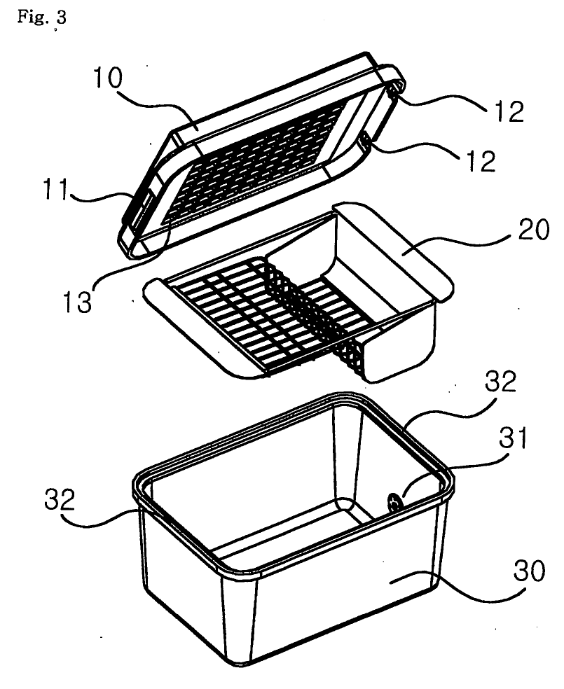

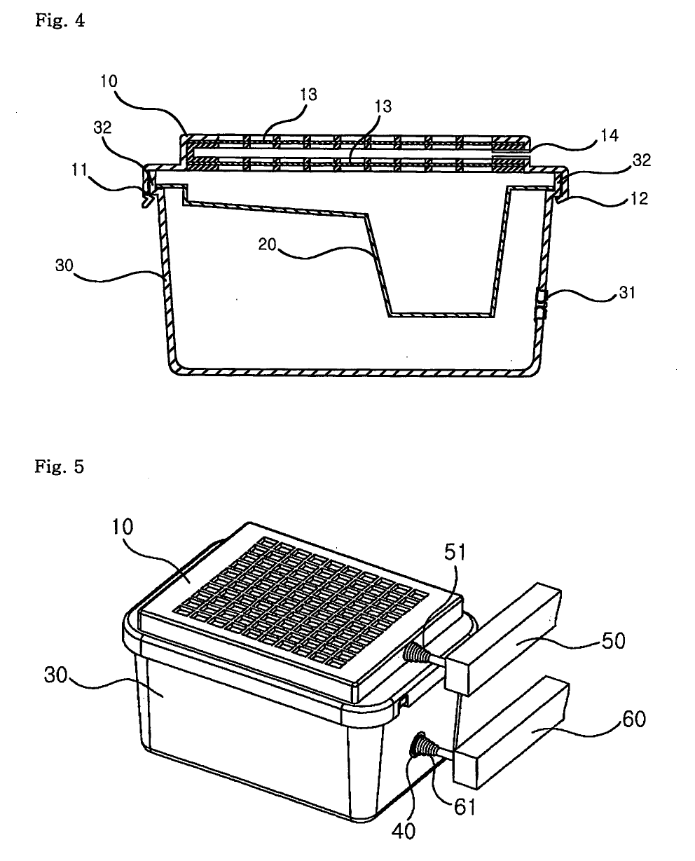

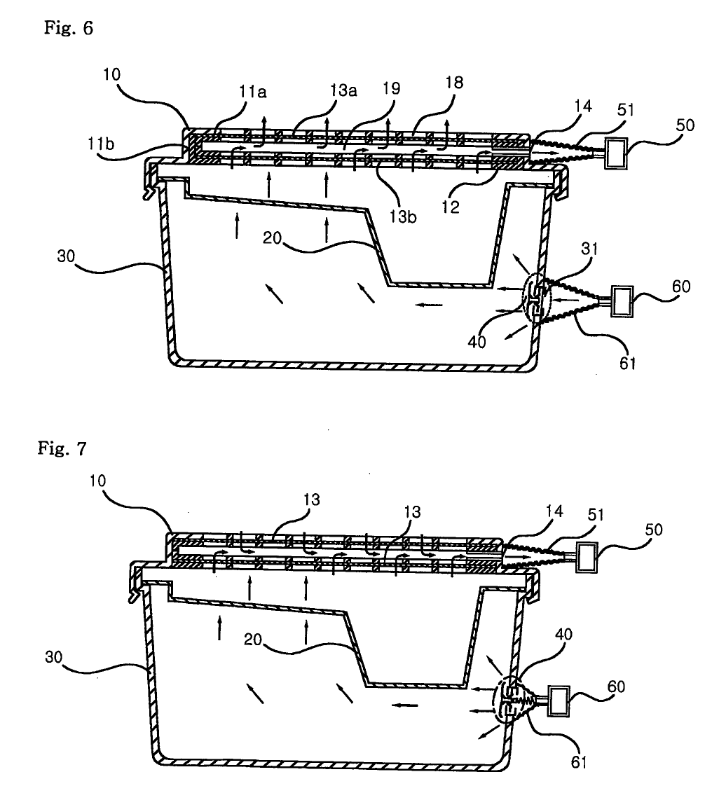

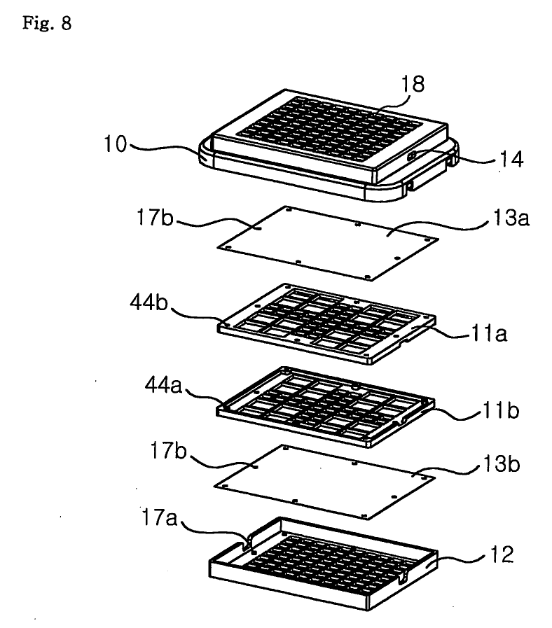

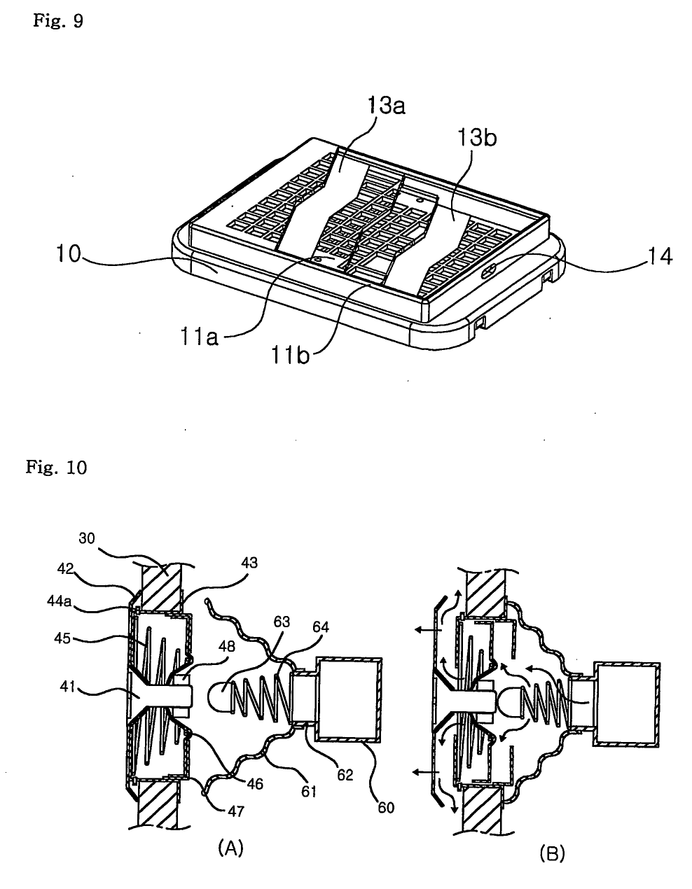

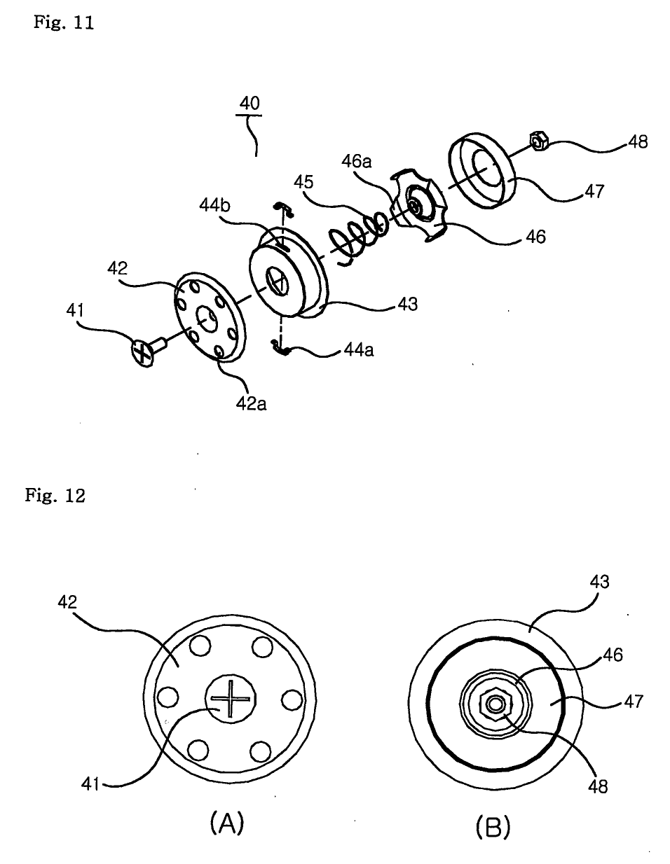

### BEST MODE FOR CARRYING OUT THE INVENTION

The present invention will now be described in detail in connection with preferred embodiments with reference to the accompanying drawings.

### EXAMPLE 1

### Laboratory Animal Breeding Cage Having Lid Fixing Apparatus

A body 30 of a laboratory animal breeding cage had a fixed jaw 32 integrally formed therewith along the edges of the upper portion thereof. The fixed jaw 32 allowed a knob 11 and fixed jaw-catching members of a lid 10 to be fixed thereto such that the lid 10 was detachably fixed to the body 30.

The lid 10 had a plurality of exhaust holes 18 formed over the entire top and bottom surfaces thereof.

The knob 11 was integrally formed with the lid 10 in the middle of the lower end of the front part of the lid 10 in such a manner as to be bent toward the inner surface of the fixed jaw 32 and then downwardly inclined toward the outside.

The two fixed jaw-catching members were integrally formed with the lid 10 at both right and left sides of the lower end of the rear part of the lid 10 in such a manner as to be bent toward the inner surface of the fixed jaw 32 and then downwardly inclined toward the outside.

The two fixed jaw-catching members formed at the rear part of the lid 10 are placed on the fixed jaw 32, and the knob 11 formed at the front part of the lid 10 was pressed downwardly to be fixed to the fixed jaw 32 such that the lid 10 was closely coupled to the body 30. Through the above steps, the laboratory animal breeding cage having a lid fixing apparatus, which includes the knob, the fixed jaw-catching members and the fixed jaw, was manufactured.

### EXAMPLE 2

### Laboratory Animal Breeding Cage Having Double Filter

The body 30 including an air supply valve 31 mounted on one side thereof was prepared.

The lid 10 had a plurality of exhaust holes 18 of a rectangular shape formed on the top and bottom surfaces thereof.

An outer filter 13a and an inner filter 13b were prepared in a known manner.

A filter fixing plate 12 had a plurality of projecting keys 17a formed thereon.

The inner fixing frame 11b had a plurality of fixing pins 44a formed thereon and the outer filter fixing frame 11a had fixing pin insertion holes 44b formed thereon.

The outer filter 13a was mounted beneath the top surface of the lid 10.

The plurality of projecting keys 17a formed on the filter fixing plate 12 were inserted into key holes 17b formed on the inner filter 13b such that the inner filter 13b was seated in the filter fixing plate 12.

Thereafter, the plurality of fixing pins 44a formed on the inner fixing frame 11b were inserted into the fixing pin insertion holes 44b formed on the outer filter fixing frame 11a such that the outer filter fixing frame 11b and the inner filter fixing frame 11a between which an exhaust space 19 was formed were fitted into the filter fixing plate 12 in which the inner filter 13b was seated.

That is, the plurality of projecting keys 17a formed on the filter fixing plate 12 were inserted into key holes 17b formed on the inner filter 13b such that the inner filter 13b was seated in the filter fixing plate 12. Next, the outer filter fixing frame 11b and the inner filter fixing frame 11a were fitted into the filter fixing plate 12 in which the inner filter 13b was seated. The filter fixing plate 12 was attached to the bottom surface. As a result, the outer filter 13a, the outer filter fixing frame 11a, the inner filter fixing frame 11b, the inner filter 13b and the filter fixing plate 12 were secured to each other to form the lid 10. The lid 10 having a double filter 13, which included the outer filter 13a and the inner filter 13b, was manufactured.

An exhaust outlet 14 was formed on one side of the lid 10 in such a manner as to be connected to the exhaust space 19. Through the above steps, the laboratory animal breeding cage having the double filter was manufactured.

### EXAMPLE 3

### Laboratory Animal Breeding Cage Having Double Safety Valve for Air Supply

The body 30 and the lid 10 were prepared.

An outer valve 46 had a central part with a hole formed in the middle thereof and five guide wing parts extending therefrom. The central part with the hole into which a clamping bolt 41 was inserted projected in such a manner that the hole is decreased in diameter as it goes. The five guide wing parts 46a functioned to guide the outer valve 46 to move in a valve body 43.

A dish-shaped inner valve 42 had a central part with a hole formed in the middle thereof and a plurality of vent holes 42a formed thereon. The central part with the hole into which the clamping bolt 41 was inserted projected in such a manner that the hole is decreased in diameter as it goes, and the plurality of vent holes 42a formed in the concentric circle were communicated with the external air.

A first spring 45 was embedded in the outer valve 46. The outer valve 46 was interposed between the valve body 43 and a fixing sleeve 47. Then, the valve body 43, the outer valve 46 and the fixing sleeve 47 are pressed by means of a presser. As a consequence, the outer valve 46 was secured to the inside of the valve body 43.

A bore was made in the body 30, and the valve body 43 to which the outer valve 46 was mounted was pushed into the body 30 through the bore. The valve body 43 was fixed to the body 30 with two fixing pins 44a.

The inner valve 42 was mounted to the outside of the valve body 43 opposite to the inside of the valve body 43 to which the outer valve 46 was mounted such that the inner valve 42 was secured to the valve body 43 with the clamping bolt 41 and a stop nut 48.

The inner valve 42 and the outer valve 46 were coupled to each other by means of the clamping bolt 41 and the stop nut 48. When the first spring 45 was pressed by a silicon rod 63 connected to a second spring 64 of an air nozzle pipe 62, the outer valve 46 was moved into the valve body 43 so as to be opened, and the inner valve 42 connected to the outer valve 46 was also pushed into the body 30 of the cage so as to be opened.

### Industrial Applicability

As described above, according to the present invention, the body and the lid can be detachably coupled to each other in a simple manner without a separate apparatus for fixing the lid to the body of the laboratory animal breeding cage. Therefore, the cage can be conveniently washed and managed and the cause of failure is eliminated, such that a life span of the cage is lengthened. By virtue of the double filter for laboratory animal care, efficiency in breeding and controlling the laboratory animals is enhanced.

Since the double filter including the outer filter and the inner filter is mounted over the entire area of the lid of the cage according to the present invention, the laboratory animals are prevented from dying after infection from various kinds of germs introduced from the outside and the life of the filter is lengthened. Both the outer filter and the inner filter are provided to the cage and thus a clinical trial under both positive pressure and negative pressure can be made.

Germfree air is evenly supplied to the cage and the inside and outside of the cage is doubly air-blocked, thereby preventing contamination.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A cage for breeding laboratory animals comprising:
a body (30) having a fixed jaw (32) integrally formed therewith along the edges of the top portion thereof; and
a lid (10) detachably fixed to the body (30), and having a knob (11) integrally formed therewith in the middle of the lower end of the front part thereof in such a manner as to be bent toward the inner surface of the fixed jaw (32) of the body (30) and then downwardly inclined toward the outside, and two fixed jaw-catching members integrally formed therewith at both right and left sides of the lower end of the rear part thereof in such a manner as to be bent toward the inner surface of the fixed jaw (32) of the body (30) and then downwardly inclined toward the outside,
wherein the knob (11) and the fixed jaw-catching members are fixed to the fixed jaw (32) of the body (30) so as to closely couple the lid (10) to the body (30).

2. A laboratory animal breeding cage having a double filter comprising:
a body (30) having an air supply valve (31) formed at one side thereof for allowing air to be introduced thereinto; and
a lid (10) removably coupled to the body (30), and having a plurality of exhaust holes (18) formed all over the top and bottom surfaces thereof, an outer filter (13a) mounted beneath the top surface thereof, an outer filter fixing frame (11a) disposed beneath the outer filter (13a), an inner filter fixing frame (11b) located beneath the outer filter fixing frame (11a), an exhaust space (19) formed between the outer filter fixing frame (11a) and the inner filter fixing frame (11b), an inner filter (13b) disposed beneath the inner filter fixing frame (11b), a filter fixing plate (12) attached to the bottom surface thereof, and an exhaust outlet (14) formed at one side thereof in such a manner as to communicate with the exhaust space (19),
wherein the outer filter (13a), the outer filter fixing frame (11a), the inner filter fixing frame (11b), the inner filter (13b) and the filter fixing plate (12) are fixedly secured to each other to form the lid (10)

3. A method for breeding laboratory animals using the laboratory animal breeding cage according to claim 2, comprising the steps of:
making the pressure of air introduced into the body (30) of the cage through the air supply valve (31) 10 to 20% lower than the suction force of the exhaust outlet (14) to let the cage be under negative pressure;
filtering the air introduced into the body (30) of the cage through the air supply valve (31) by means of the inner filter (13b) when the introduced air is contaminated after being used for animal respiration, and discharging the contaminated air to the exhaust space (19) and further discharging the same through the exhaust outlet (14) to an exhaust pipe (50); and
at the same time, sucking external air into the cage by means of the outer filter (13a) due to a difference between the air pressure inside the cage and the air pressure outside, and discharging the sucked air through the exhaust space (19) to the exhaust pipe (50).

4. A double safety valve of a lap animal breeding cage, comprising:
a valve body (43);
a fixing sleeve (47);
an outer valve (46) having a first spring 45 embedded therein and interposed between the valve body (43) and the fixing sleeve (47) in such a manner as to be mounted to the inside of the valve body (43) by means of the fixing sleeve (47); and
an inner valve (42) mounted to the outside of the valve body (43) opposite to the inside of the valve body (43) to which the outer valve (46) is mounted;
wherein the inner valve (42) and the outer valve (46) are coupled to each other by means of a clamping bolt (41) and a stop nut (48), and when the first spring (45) is pressed by a silicon rod (63) connected to a second spring (64) of an air nozzle pipe (62), the outer valve (46) is moved into the valve body (43) so as to be opened, and the inner valve (42) connected to the outer valve (46) is also pushed into a body (30) of the cage so as to be opened.

5. The double safety valve according to claim 4, wherein the outer valve (46) has three to five guide wing parts (46a) extending therefrom for guiding the outer valve (46) to move in the valve body (43), and the inner valve (42) has a plurality of vent holes (42a) formed thereon for allowing air to pass therethrough.
